(19) United States
(12) Patent Application Publication
(10) Pub. No.: US 2003/0141940 A1
(43) Pub. Date: Jul. 31, 2003

(54) Transition between a microstrip line and a rectangular waveguide

(75) Inventors: Christelle Le Bihan, Courbevoie (FR); Philipe Poire, Plaisance du Touch (FR)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/352,099

(22) Filed: Jan. 28, 2003

(30) Foreign Application Priority Data
Jan. 30, 2002 (EP) 02 360 048.9

(51) Int. Cl. H01P 5/107

(52) U.S. Cl. 333/26

(57) ABSTRACT

The invention relates to a method of resolving collisions between at an arrangement with a flat board comprising microwave integrated modules and at least one microstrip lines for guiding a signal on said flat board and a waveguide for guiding the signal out of the flat board. According to the present invention the flat board is perforated at the intersection between the flat board and the waveguide, a stand-alone piece of comprising a microstrip line termination and being adjusted over the perforation, the microstrip line termination coinciding with the extremity of one microstrip line on the flat board.

The invention is based on a priority application EP 02 360 048.9 which is hereby incorporated by reference.

### BACKGROUND OF THE INVENTION

The present invention relates to microwave transmission and more precisely to a transition between a microstrip line and a rectangular waveguide both dedicated to transmit a microwave signal.

The output stage of a microwave radio transmitter comprises integrated microwave modules consisting microwave components mounted on the surface of a “flat” motherboard using preferably the M-SMT technology (microwave surface mount technology). Such components may be amplifiers, mixers, attenuators.

The microwave signals generated in the components are usually propagated through microstrip lines between the different components. Microstrip lines have the advantage to be flat and require not a lot of space.

The signal has further to be propagated from the motherboard to the antenna of the microwave radio transmitter. Contrary to the motherboard where the signal is localised on a microstrip line, a rectangular waveguide forwards the signal to the antenna. The transition between the microstrip line and the rectangular waveguide should be properly adapted to avoid signal loss at the transition which would create unwanted interference in the microwave module.

A known solution for providing an appropriate transition between a microstrip line located on a motherboard and a rectangular waveguide is described in FIG. 1. FIG. 1a is a top elevation view of the mother board while FIG. 1b is a side view of the transition between the microstrip line and the rectangular waveguide along line A-A.

In this arrangement, the rectangular waveguide 11 is perpendicular to the plane of the motherboard 10 as shown on the view illustrated on FIG. 1b.

The extremity of a microstrip line 101 printed on the motherboard 10 is the transition point to the rectangular waveguide 10 and is substantially located at the center of the section of rectangular waveguide 11.

A cover 12 located over motherboard 10 on the other side of motherboard 10 as rectangular waveguide 11 acts as closed extremity of rectangular waveguide 11. For this purpose conductive paste is deposited over the edge of the conductive cover acting as closed extremity of the waveguide. The conductive paste is in contact with metallized holes perforated on the motherboard. The metallized holed ensure the contact with the rectangular waveguide 11.

The material of motherboard 10 being namely transparent to microwaves usually having a frequency roughly between 1GHz and 30GHz and is thin enough not to prevent the propagation of the microwave signal through it.

This arrangement presents a drawback for multilayer motherboards used in order to increase the number of components on a single motherboard. Several layers using the microwave surface mount technology being assembled together. Several layers of substrate render the motherboard thicker. As a consequence, the signal is attenuated at the transition to the rectangular waveguide. This attenuation reduce the performance of the microwave module.

A particular object of the present invention is to provide an arrangement for a transition between a microstrip line and a waveguide which reduce the signal attenuation at the transition point.

Other objects of the invention is to provide a radio transmitter such a such arrangement as well as a method for manufacturing such an arrangement.

### SUMMARY OF THE INVENTION

These objects, and others that appear below, are achieved by an arrangement comprising

a flat board comprising microwave integrated modules and at least one microstrip line for guiding a signal on said flat board) and

a waveguide for guiding said signal out of said flat board,

wherein said flat board is perforated at the intersection between said flat board and said waveguide, a stand-alone piece of dielectric comprising a microstrip line termination and being adjusted over said perforation of said flat board, said microstrip line termination coinciding with the extremity of said microstrip line on said flat board.

These objects are further achieved by a microwave radio transceiver comprising an arrangement with

a flat board comprising microwave integrated modules and at least one microstrip line for guiding a signal on said flat board) and

a waveguide for guiding said signal out of said flat board,

wherein said flat board is perforated at the intersection between said flat board and said waveguide, a stand-alone piece of dielectric comprising a microstrip line termination and being adjusted over said perforation of said flat board, said microstrip line termination coinciding with the extremity of said microstrip line on said flat board.

According to the present invention, a perforation (hole) is made in the motherboard at the place corresponding to the extremity of the waveguide. This hole prevents the thick substrate from attenuating the signal at the transition between the microstrip and the waveguide.

Moreover, a stand-alone piece of dielectric having a microstrip line termination is placed above the hole and acts as the termination of the microtrip line.

The stand alone piece must be adjusted on the motherboard so that the contact is ensured between the extremity of the microsprip line at the edge of the hole and the microstrip line termination on the stand-alone piece of dielectric.

The method according to the present invention presents the advantage to increase the performance of the microwave module comprising a transition according to the present invention in that the dielectric material can be chosen to be as transparent a possible to the microwave especially for multilayer integrated microwave circuits.

In a preferred embodiment of the present invention, the standalone piece of dielectric act additionally as closed extremity of the rectangular waveguide. For this purpose, the piece of dielectric is metallized on its top and on its sides.

This embodiment further presents the advantage to reduce the complexity of manufacturing the microwave module in that the cover needs no more to ensure a perfect electric contact with the waveguide.

Further advantageous features of the invention are defined in the dependent claims.

### BRIEF DESCRIPTION OF THE DRAWINGS

Other characteristics and advantages of the invention will appear on reading the following description of a preferred embodiment given by way of non-limiting illustrations, and from the accompanying drawings, in which:

FIG. 1 shows a prior art arrangement for ensuring a transition between a microstrip line and a rectangular waveguide;

FIG. 2 shows a motherboard presenting a perforation according to the present invention;

FIG. 3 illustrates a stand-alone piece according to the present invention;

FIG. 4 represents the stand-alone piece mounted on the motherboard according to the present invention.

### DETAILED DESCRIPTION OF THE INVENTION

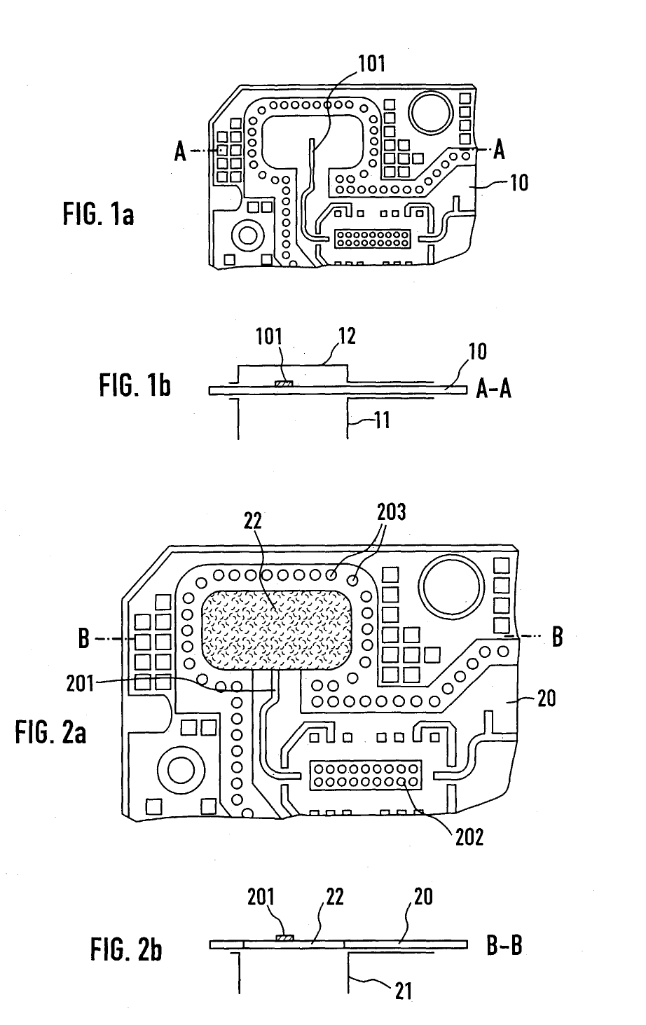

FIG. 1 has already been described in connection with prior art.

FIG. 2 shows a motherboard presenting a hole according to the present invention.

FIG. 2a is a top elevation view of a motherboard 20 while FIG. 2b is a side view of motherboard 20 and a waveguide 21 perpendicular to the plane of the motherboard 20 along line B-B.

In this embodiment, the waveguide is chosen rectangular. The invention is however not limited to a rectangular waveguide. Circular waveguide or any other type of hollow waveguide or filled in with a dielectric can be used as well.

In this arrangement, a hole 22 having substantially the shape of waveguide 21 section is perforated on the part of motherboard 20 coinciding with the intersection with waveguide 21.

A microstrip line 201 printed on motherboard 20 transports the microwave between components 202 located on motherboard 20 and ends at the edge of hole 22.

substantially located at the center of the section of rectangular waveguide 11.

A conductive cover (not represented) can be put above motherboard 20. A conductive paste can be deposited between the conductive cover and metallized holes 203 perforated on motherboard 20. The metallized holes ensure the electric contact with rectangular waveguide 11 and a cover (as cover 12 shown on FIG. 1b) can act as closed extremity of waveguide 11.

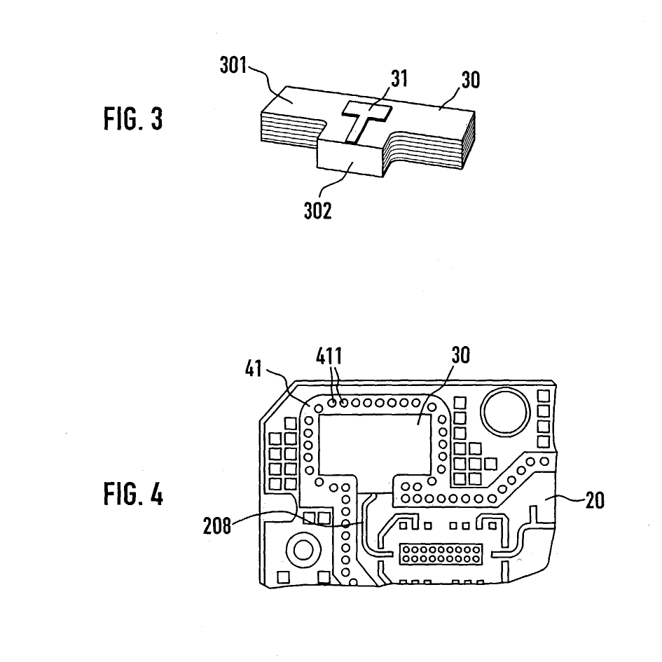

FIG. 3 illustrates a stand-alone piece 30 according to the present invention.

Stand alone piece 30 is a piece of dielectric comprising on its surface a microstrip line termination 31. The dielectric is chosen to be transparent to microwave possible materials are 25N substrate form the company Arlon or RO4003 from the company Rogers Corp. The used dielectric material depends preferably of the frequency range generated and transported on motherboard 20.

The shape of stand alone piece is preferably and an arrangement of two parallelepipeds: the first one 301 having a basis shape substantially identical to the shape of hole 22 and the second one 302 supporting the extremity of microstrip line termination 301 which have to be connected to the extremity of the microstrip line termination 201 located on motherboard 20. The other extremity of microstrip line termination on stand alone piece 30 being substantially located at the center of first parallelepiped 301.

In a preferred embodiment of the invention, the surface of parallelepiped 301 opposite to the surface supporting microstrip line termination 31 as well as the surfaces perpendicular to this surface are metallized. This results in that stand alone piece has also the function of the closed extremity of waveguide 21.

In this embodiment, the height h of both parallelepipeds 301, 302 is chosen so as to propagate the microwave in waveguide 21 without generating reflections due to characteristic impedance discontinuity (mismatch) at the transition between waveguide 21 and the microstrip line. These reflections would induce losses and degrade the system behavior.

The size of stand alone piece 30 presented on FIG. 3 is l/w/h: 6.5 mmm/5 mm/1.5 mm. A person skilled in the art will understand that any other dimension may be selected or adapting stand alone piece 30 to a particular motherboard 20/waveguide 21 arrangement.

It will be clear for a person skilled in the art, that the shape of stand alone piece 30 can be chosen a different way to fulfil the same function i.e. supporting and bringing microstrip line termination 31 at the center of waveguide 21 and optionally acting as a closed extremity of waveguide 21. The shape of stand alone piece 30 depends preferably on the shape of the section of waveguide 21.

FIG. 4 represents stand-alone piece 30 mounted on motherboard 20 according to the present invention. Stand alone piece 30 is mounted on motherboard 20 on hole 22 so that microstrip line termination 31 coincides with the extremity of microstip line 201. Stand alone piece 30 is preferably fixed on motherboard 20 by using glue. Stand-alone piece 30 will preferably be put in a tap and reel feeding system when manipulated in a Surface Mounted Technology assembly line. Several stand-alone pieces 30 are preferably manufactured together as attached to a panel, the microstrip line terminations and the metal layer being automatically applied to each stand alone pieces attached to the panel. The stand-alone pieces can after manufacture be separated from the panel for further use.

In a preferred embodiment of the present invention, the metallized surface on the side of stand alone piece 30 contacts with the metallized rubban 41 around hole 22 perforated with metallized holes 411. Waveguide 21 contacts also with these metallized holes on the other side of motherboard 20. As a consequence the metallized surface on the top an on the sides of stand-alone piece 30 cat as the closed extremity of waveguide 21. In another embodiment of the present invention, the metallized sides of stand alone piece 30 can be replaced by a fence of metallized holes along each of the four sides. Using holes increases the processing yields since it is difficult to deposit a metal layer on a large surface of dielectric material.

In a preferred embodiment of the present invention, a multilayer mother board is used. Each layer of the mother board comprising surface mounted corposants and a microstrip line ending at the edge of hole 22. It is important to ensure the electric contact between all extremities of microstrip lines at the edge of hole 22 and microstrip line termination 31. A solution to this problem consists in providing an electric contact linking all extremities of the microstrip lines belonging to the different mother board layers and connecting this electric contact with microstrip line termination 31.

In a further embodiment of the present invention, several microstrip line terminations can be supported on stand alone piece 30, each microstrip line termination being connected to the extremity of a microstrip line of a different layer of the motherboard. An arrangement comprising a stand-alone piece according to the invention used as transition between a microstrip line on a flat board an a waveguide may preferably be used in a microwave radio transceiver, the waveguide propagating a microwave to/from an antenna and the microstrip line propagating the microwave to/from the input/output stage of the transceiver.

1/ Arrangement comprising:
a flat board comprising microwave integrated modules and at least one microstrip line for guiding a signal on said flat board) and
a waveguide for guiding said signal out of said flat board, wherein said flat board is perforated at the intersection between said flat board and said waveguide, a stand-alone piece of dielectric comprising a microstrip line termination and being adjusted over said perforation of said flat board, said microstrip line termination coinciding with the extremity of said microstrip line on said flat board.

2/ Arrangement according to claim 1, wherein said stand alone piece of dielectric comprises metallized surfaces in contact with said flat board and coinciding with the waveguide extremity in contact with said flat board, said metallized surfaces acting as closed extremity of said waveguide.

3/ Arrangement according to claim 1, wherein said stand-alone piece is made out of a dielectric substantially transparent to microwaves.

4/ Arrangement according to claim 1, wherein said stand alone piece of dielectric has the shape of two assembled parallelepipeds, a first one having substantially the shape of said perforation, a second being used to fix said stand alone piece of dielectric on said flat board.

5/ Arrangement according to claim 1, wherein said flat board comprises surface mount technology components.

6/ Arrangement according to claim 1, wherein said flat board is a multilayer flat board comprising at least two layer of surface mounted components.

7/ Arrangement according to claim 1, wherein it is part of a microwave radio transceiver, said waveguide propagating a microwave between said antenna and said flat board supporting the input/output stage of said transceiver.

8/ Microwave radio transceiver comprising an arrangement according to claim 1.
